(19) United States
(12) Patent Application Publication
(10) Pub. No.: US 2008/0110285 A1
(43) Pub. Date: May 15, 2008

(54) Roller Screw System

(76) Inventors: Hung-Sung Pan, Taichung Industrial Park (TW); Wen-Chia Wu, Taichung Industrial Park (TW)

Correspondence Address: Dr. BANGER SHIA, 102 Lindencrest Ct., Sugar Land, TX, 77479-5201, US

(21) Appl. No.: 11/559,406

(22) Filed: Nov. 14, 2006

(51) Int. Cl. F16H 25/22

(52) U.S. Cl. 74/424.86

(57) ABSTRACT

A roller screw system comprises a screw shaft, a nut, a pair of return members, a return pipe and a plurality of rollers. The nut is interiorly defined with a receiving recess for accommodation of the return members, and an abutting surface. The roller screw system is characterized in that a through hole is defined in the nut and is in communication with the return hole. The return pipe is disposed in the through hole of the nut. The return members are disposed in the receiving groove of the nut, forming a return system. And the return system is to be connected to the helical groove of the screw shaft and the nut, thus forming a roller screw system. By such arrangements, the rollers can circulate more smoothly and the size of the nut will not be increased.

### BACKGROUND OF THE INVENTION

1. Field of the Invention

The present invention relates to a roller screw system, and more particularly to an engaging positioning structure between the return members and the return pipe, which is used in the roller screw to enable the rollers to circulate more smoothly and can reduce the size of the nut.

2. Description of the Prior Art

Linear guideway is used more and more widely in modern industries. In addition to its high precision transmission performance, the linear guideway also has many other advantages, such as low friction loss, high ratio of energy conversion, low noise, high rigidity and wear-resistance. Therefore, it is self-evident that the linear guideway is very important to various industrial mechanisms. Normally, the linear guideway is provided at both ends of its sliding block with a return portion (it is usually defined on the end caps of the sliding block) for enabling the rolling elements between the screw shaft and the nut to circulate endlessly. The return portion is the key to enable the rolling elements to circulate.

The existing roller screw generally comprises screw shaft, nut and rollers.

The commonly seen roller circulation method essentially includes inner circulation and outer circulation. Regarding the inner circulation, each thread of the screw shaft forms a circulation ring, so that the resultant drag force and abrasion is small and few. However, it must use the outer circulation type roller screw when the load to be loaded is comparatively large. However, the outer circulation type roller screw needs to install a return pipe on the outer periphery of the nut to guide the circulation of the roller. Therefore, the size of nut will definitely be increased. In order to reduce the size of the nut while increasing its loading capacity, it must take the inner circulation type roller screw.

FIG. 1 shows an outer circulation type roller screw disclosed in U.S. Pat. No. 3,192,791, wherein a return pipe 8 is installed on the outer surface of the nut 7 to guide the circulation of the rollers 10. The return pipe 8 is rectangular-shaped 9 in cross section. Such a conventional product still has the following problems that need to be improved:

Firstly, in addition to the fact that the return pipe 8 is difficult to shape and manufacture, the size of the nut will also be increased by the installation of the return pipe 8.

Secondly, when the number of the rollers 10 and the return curves of return pipe are relatively large, the rollers 10 are unlikely to move smoothly through the return pipe 8, since the rollers 10 will impact the return portion of the return pipe 8 before entering the circulation system, and the circulation route is not continuously smooth.

The present invention has arisen to mitigate and/or obviate the afore-described disadvantages.

### SUMMARY OF THE INVENTION

The primary objective of the present invention is to provide a roller screw system that can enable the rollers to circulate more smoothly while reducing the size of the nut.

To obtain the abovementioned objective, the roller screw system in accordance with the present invention comprises a screw shaft, a nut, a pair of return members, a return pipe and a plurality of rollers. The nut is interiorly defined with a receiving recess for accommodation of the return members, and an abutting surface. The roller screw system is characterized in that a through hole is defined in the nut and is in communication with the return hole. The return pipe is disposed in the through hole of the nut. The return members are disposed in the receiving groove of the nut, forming a return system. And the return system is to be connected to the helical groove of the screw shaft and the nut, thus forming a roller screw system. By such arrangements, the present invention can solve the problems of the conventional roller screw, such as the turning radius is too small and leads to an unsmooth circulation of the roller, or the return pipe increases the size of the nut.

### BRIEF DESCRIPTION OF TEIE DRAWINGS

FIG. 1 shows a conventional roller screw disclosed by U.S. Pat. No. 3,192,791;

FIG. 2 is a perspective view of a roller screw system in accordance with the present invention;

FIG. 3 is an exploded view of showing the return members and the return pipe in accordance with the present invention;

FIG. 4 is an assembly view showing the return members and the return pipe in accordance with the present invention;

FIG. 5 is an exploded view of showing the roller screw system in accordance with the present invention; and

FIG. 6 is an assembly view of showing the roller screw system in accordance with the present invention.

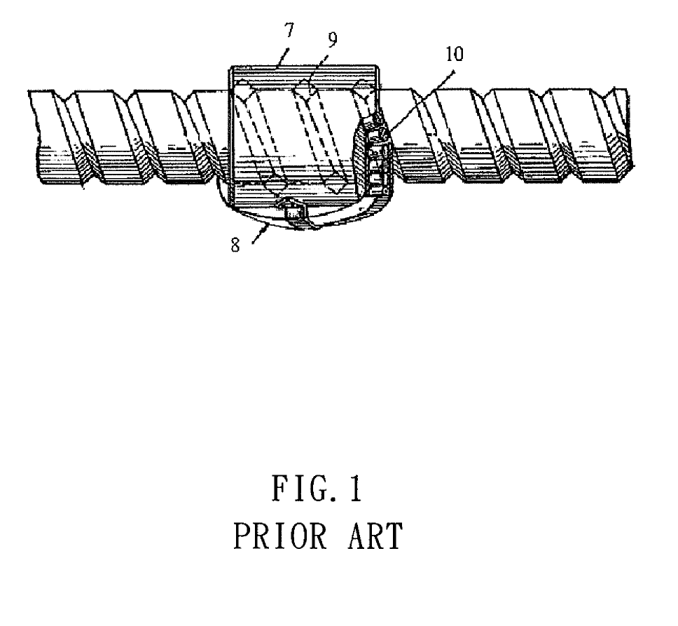

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

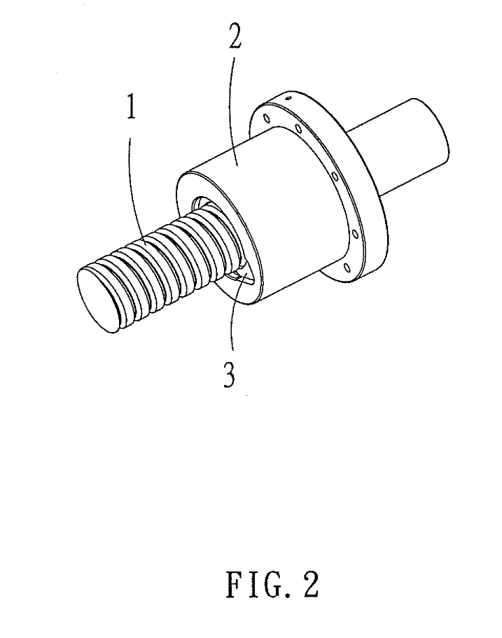

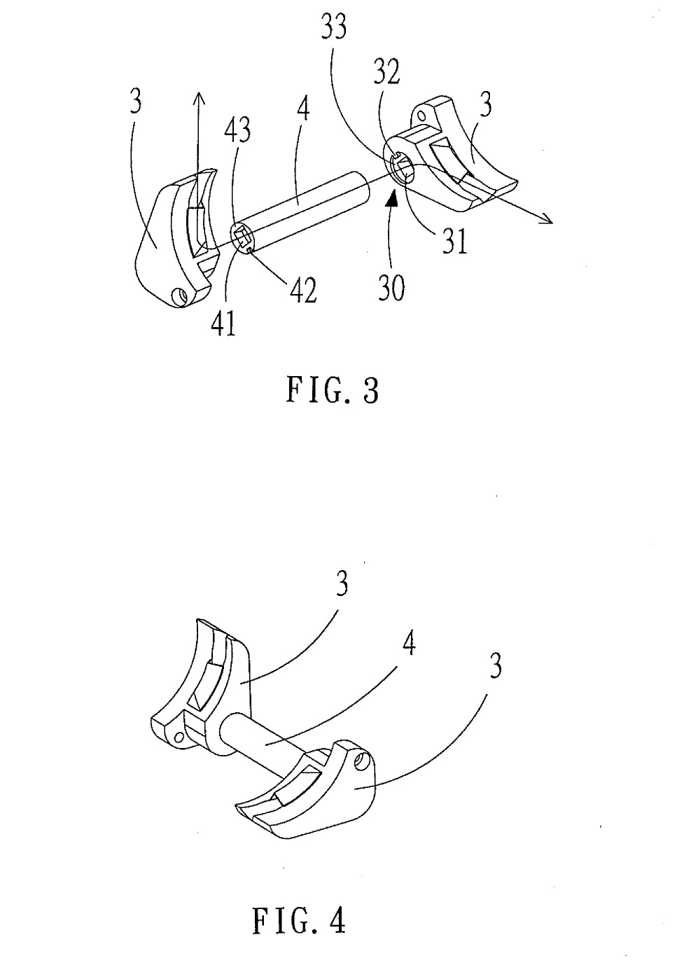

Referring to FIGS. 2-6, a roller screw system in accordance with a preferred embodiment of the present invention comprises a screw shaft 1, a nut 2, a pair of return members 3, a return pipe 4 and a plurality of rollers 5. The nut 2 is interiorly defined with a receiving recess 22 for accommodation of the return members 3, and an abutting surface 23.

The nut 2 is formed in its abutting surface 23 with a through hole 21 for connecting a return hole 30 in each of the return members 3.

Each of the return members 3 is interiorly defined with a return path for the rollers 5 and the return hole 30, and the return hole 30 is formed at the end thereof with a square cross section 31.

The return pipe 4 is formed with a return path for the rollers 5, both ends 43 of the return pipe 4 are also formed with a square cross section 41 for cooperating with the square cross section 31 of the return hole 30. Since it is likely that there is an angle difference between the square cross sections 31 that cooperate with the both ends of the return pipe 4, namely, the square cross sections 41 at both ends of the return pipe 4 should be arranged at an angle. The return path inside the return pipe 4 must be twisted so as to produce an angle difference between the square cross sections 31 for cooperating with the both ends of the return pipe 4.

The square cross sections 31 of the return members 3 are aligned with the square cross sections 41 at the both ends 43 of the return pipe 4. The return pipe 4 is inserted in the through hole 21 of the nut 2, and the return members 31 are disposed in the receiving recess 22 of the nut 2, forming a return system. And the return members 31 are to be connected to the helical groove of the screw shaft 1 and the nut 2, thus forming a roller screw system.

The relative position between an engaging block 32 of the return members 3 and an engaging groove 42 of the return pipe 4 might be varied according to design requirements.

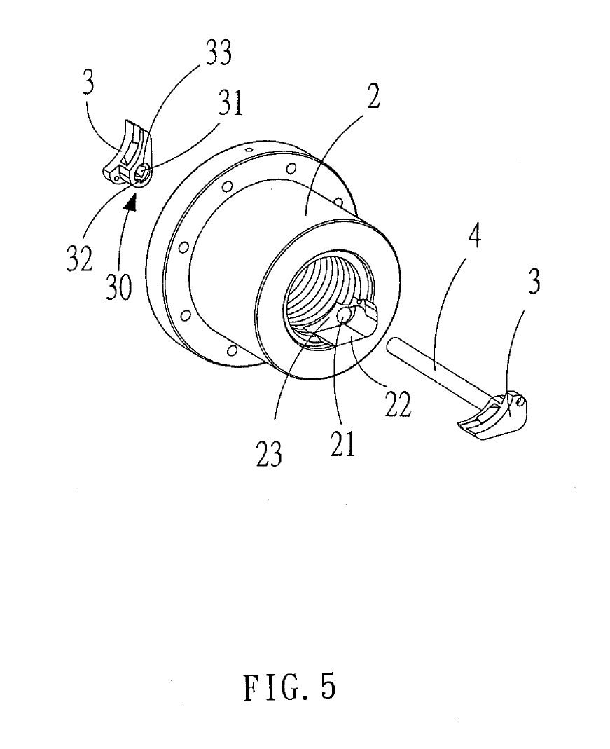

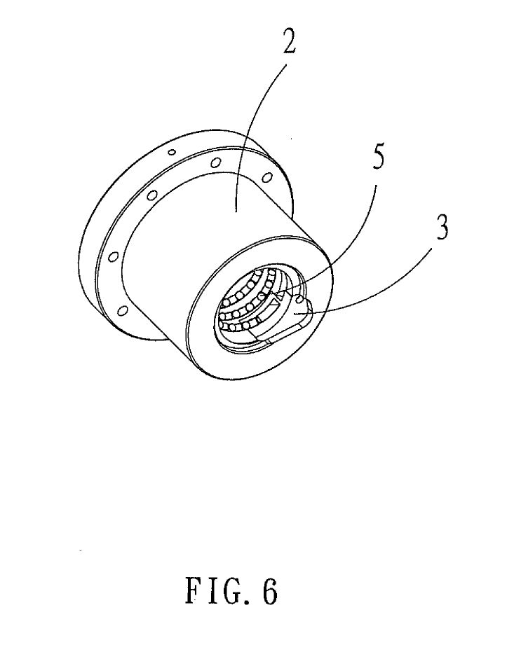

For a better understanding of the function and operation of the present invention, reference should be made to FIGS. 5 and 6. In assembly, the screw shaft 1 is initially inserted in the nut 2, so that a space for accommodation of the plurality of rollers 5 is defined between the helical groove of the screw shaft 1 and the nut 2. And then the engaging block 32 of one of the return members 3 can be engaged in the engaging groove 42 of the return pipe 4. After that, the return pipe 4 is inserted in the through hole 21 at the end of the nut 2, the return member 3 is inserted in the receiving recess 22 of the nut 2 and abuts against the abutting surface 23. And the plurality of rollers 5 is then inserted in the helical groove. Finally, the other return member 3 is then inserted into the receiving recess 22 of the nut 2, and the engaging block 32 of the return member 3 is engaged in the engaging groove 42 of the return pipe 4.

The present invention uses the following methods to effectively solve the problems of the conventional roller screw:

1. Increase the turning radius for the rollers (the radius of the return path), allowing the rollers to move more smoothly when passing through the return path.

2. the return path is defined in the nut without increasing the size of the nut.

3. the components used in the return path of the rollers are made by the relatively stable injection molding, and then the components are assembled together to cover the entire return path, thus reducing the occurrence of machining caused errors.

4. As compared with the conventional rolling elements-rolling balls, the return path of the roller circulation system is square in cross section. Therefore, the influence of the angle difference between the respective components of must be taken into consideration. The return path of the ball circulation system is circular in cross section, so it doesn't need to think about the angle-difference caused level difference at the connection of the return path.

Therefore, the present invention utilizes the positioning structure between the return pipe and the return members to eliminate the uneven level difference of the return path, this notion is totally different from the ball circulation system, especially, the angle difference between the two square cross section at both ends of the return pipe.

In addition, the shape of the nut is the same as that of the end cap type ball circulation system, thus reducing the complexity of the machining.

The return path of the return pipe is twisted, it not only enables the rollers' circulation path to be connected smoothly without level difference, but also prevents the rollers from impacting the return portion, thus allowing the rollers to move smoothly.

To summarize, the roller screw system in accordance with the present invention comprises a screw shaft, a nut, a pair of return members, a return pipe and a plurality of rollers. The nut is interiorly defined with a receiving recess for accommodation of the return members, and an abutting surface. The roller screw system is characterized in that a through hole is defined in the nut and is in communication with the return hole. The return pipe is disposed in the through hole of the nut. The return members are disposed in the receiving groove of the nut, forming a return system. And the return system is to be connected to the helical groove of the screw shaft and the nut, thus forming a roller screw system.

By such arrangements, the present invention can solve the problems of the conventional roller screw, such as the turning radius is too small and leads to an unsmooth circulation of the roller, or the return pipe increases the size of the nut.

While we have shown and described various embodiments in accordance with the present invention, it is clear to those skilled in the art that further embodiments may be made without departing from the scope of the present invention.

What is claimed is:

1. A roller screw system comprising: a screw shaft, a nut, a pair of return members, a return pipe and a plurality of rollers, the nut being interiorly defined with an abutting surface and a receiving recess for accommodation of return members, characterized in that:
a through hole is formed in the abutting surface of the nut for connecting a return hole in each of the return members;
a return path for the rollers and the return hole are formed in each of the return members, and the return hole is formed at an end thereof with a square cross section;
the return pipe is formed with a return path for the rollers, both ends of the return pipe are also formed with a square cross section;
the square cross sections of the return members are aligned with the square cross sections of the return pipe, the return pipe is inserted in the through hole of the nut, and the return members are disposed in the receiving recess of the nut, forming a return system, and the return member are to be connected to the helical groove of the screw shaft and the nut, thus forming a roller screw system.

2. The roller screw system as claimed in claim 1, wherein an engaging block is formed on each of the return members, and an engaging groove is formed in either end of the return pipe.

3. The roller screw system as claimed in claim 1, wherein the square cross sections at both ends of the return pipe are arranged at an angle relative to each other.

4. The roller screw system as claimed in claim 3, wherein the return path inside the return pipe is twisted.
